(19) United States
(12) Patent Application Publication
(10) Pub. No.: US 2004/0228965 A1
(43) Pub. Date: Nov. 18, 2004

(54) Method for surface treatment of lithium manganese oxide for positive electrode in lithium secondary battery

(76) Inventors: Jai Young Lee, Daejeon Kwangyeok-si (KR); Sung Chul Park, Daejeon Kwangyeok-si (KR); Young Soo Han, Daejeon Kwangyeok-si (KR); Youn Seon Kang, Daejeon Kwangyeok-si (KR); Yong Mook Kang, Daejeon Kwangyeok-si (KR); Sang Cheol Han, Daejeon Kwangyeok-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 10/868,881

(22) Filed: Jun. 17, 2004

Related U.S. Application Data
(63) Continuation-in-part of application No. 09/731,017, filed on Dec. 7, 2000, now abandoned.

(51) Int. Cl. B05D 5/12; H01M 4/50

(52) U.S. Cl. 427/126.3; 429/231.1; 429/224

(57) ABSTRACT

A method for surface treatment of lithium manganese oxide for positive electrodes in lithium secondary batteries is provided in which the surface of the lithium manganese oxide is coated with lithium transition metal oxides. The lithium secondary batteries using the coated lithium manganese oxide as an anode material not only solves the problems with the conventional lithium secondary batteries in regard to the lifetime of the electrodes at high temperature and the fast discharge efficiency, but also replace the conventional expensive lithium cobalt oxide to reduce the production cost.

### RELATED PATENT APPLICATIONS

This patent application is a Continuation-in-Part of U.S. patent application Ser. No. 09/731,017 filed on 7 Dec. 2000.

### BACKGROUND OF THE INVENTION

1. Field of the Invention

The present invention relates to a method for surface treatment of lithium manganese oxide for positive electrodes in lithium secondary batteries and, more particularly, to a method for surface treatment of lithium manganese oxide to enhance the lifetime of the electrodes at high temperatures and the fast discharge efficiency without a deterioration of the discharge capacity. Throughout the present disclosure, the term “anode material” is meant to be synonymous with “positive electrode material” and should be understood to signify the same thing.

2. Description of the Related Art

With a rapid development of portable electric appliances such as notebook computer, camcorder, hand phone and small-sized recorder, the electric appliances are in increased demand and their energy source, i.e., batteries become more important. Furthermore, reusable secondary batteries are increasingly in great demand. Especially, lithium secondary batteries are being studied in earnest and most commercialized due to their high energy density and high discharge voltage.

The most important part of the lithium secondary battery is a material constituting negative and positive electrodes. In particular, the anode material of the lithium secondary batteries has to meet some requirements as follows: (1) low price of the active material, (2) high discharge capacity, (3) high working voltage to attain high energy density, (4) long lifetime of the electrodes for long-term use, and (5) high fast discharge efficiency to enhance the energy density per volume and the peak power per weight.

The first commercialized anode material for the lithium secondary battery is lithium cobalt oxides, which are excellent in the lifetime of the electrodes and the fast discharge efficiency but excessively expensive. As the use of large-sized lithium secondary batteries, for example, in electric motorcars causes a problem in regard to the price of the anode material in the development of batteries, many attempts have been made to replace the conventional anode material with an inexpensive and environment-friendly anode material. However, such an anode material is mush inferior in the lifetime of the electrodes and the fast discharge efficiency and also problematic in the aspect of manufacture. For example, lithium manganese oxides are readily destroyed in the structure and reactive to the organic solvent used as an electrolyte to dissolve the manganese ions into the electrolyte due to Jahn-Teller distortion in the course of charge and discharge operations, which results in an abrupt deterioration of the lifetime of the electrodes. It also seems that such a deterioration of the lifetime of the electrodes are greatly increased with a rise of the working temperature of the batteries.

Many studies have been made on the method for improving the problems with the lithium manganese oxides, particularly, by replacing manganese of the lithium manganese oxide with a hetero-transition metal. M. M. Thaekeray et al. (Slid State Ionics, 69(1994), 59-67) replaced manganese of the lithium manganese oxides with magnesium or zinc, and D. Zhang et al. (Journal of Power Sources, 76(1998), 81-90) replaced manganese with chromium to enhance the lifetime of the electrodes at the room temperature. Also, J. R. Dahn et al. (Journal of Electrochem, Soc., 144(1997), 205) suggested a replacement of manganese with nickel to enhance the lifetime of the electrodes at the room temperature. Apart from the displacement methods, G. G. Amatucci et al. (Solid State Ionics, 104(1997), 13-25) coated the surface of the lithium manganese oxide with amorphous lithium oxide to reduce the irreversible electrode capacity.

These methods somewhat improve the lifetime of the electrode at the room temperature but fail to enhance the lifetime of the electrode at high temperatures and the fast discharge efficiency with a deterioration of the discharge capacity, thus resulting in unsatisfactory lithium secondary batteries.

### SUMMARY OF THE INVENTION

The inventors of this invention have found out that coating a lithium transition metal oxide such as lithium cobalt oxide on the surface of the lithium manganese oxide used as a promising anode material for lithium secondary batteries can improve the lifetime of the electrodes at high temperatures and the fast discharge efficiency without a deterioration of the discharge capacity.

It is, therefore, an object of the present invention to provide a method for surface treatment of lithium manganese oxide for positive electrodes in the lithium secondary batteries to enhance the lifetime of the electrodes at high temperatures and the fast discharge efficiency without a deterioration of the discharge capacity.

To achieve the above object of the present invention, there is provided a method for surface treatment of a lithium manganese oxide for positive electrodes in lithium secondary batteries, in which the surface of the lithium manganese oxide is coated with a lithium transition metal oxide.

In another aspect of the present invention, there is also provided a lithium secondary battery using the lithium manganese oxide prepared by the above method as an active material for the positive electrodes.

The surface of the lithium manganese oxide is coated with the lithium transition metal oxide by a liquid phase coating method that includes the steps of:

(a) weighing a sample of a lithium compound and a transition metal compound and dissolving the weighed compound in a solvent to prepare a mixed solution feedstock;

(b) adding glycolic acid, adipic acid, citric acid, or propionic acid;

(c) adjusting the pH value of the solution;

(d) heating the solution to control the concentration of metal ions;

(e) adding the lithium manganese oxide to the solution to prepare a second mixed solution;

(f) filtering out from the second mixed solution the lithium manganese oxide surface-coated with the lithium transition metal oxide; and

(g) drying and heat-treating the resulting lithium manganese oxide.

Now, a detailed description will be given below as to the steps (a) to (g).

Examples of the compounds for forming the feedstock include acetates, hydroxides, nitrates, sulfates or chlorides of Li, and acetates, hydroxides, nitrates, sulfates or chlorides of a metal selected from the group consisting of Co, Fe, Mn, V, Cr, Cu, Ti, W, Ta, Ni, and Mo.

The weighed feedstock is dissolved in a solvent selected from the group consisting of distilled water, alcohol, acetone, a mixed solution of distilled water and alcohol at the mixing ratio of 1:1 to 9:1, a mixed solution of distilled water and acetone at the mixing ratio of 1:1 or 9:1, and a mixed solution of alcohol and acetone at the mixing ratio of 1:1 to 9:1 in the temperature range of 80 to 90° C. with a stirrer. To the resulting solution is added glycolic acid, adipic acid, citric acid or propionic acid in an amount one to three times the total weight of metal ion compounds. Following the addition of the glycolic acid, adipic acid or citric acid, ammonia water is added as a base to control the pH value of the solution in the range from 6 to 8. Subsequently, the solution is refluxed in a constant concentration of metal ions of about 1 M at 80 to 90° C. for 6 to 12 hours.

The distilled water is vaporized to control the concentration of the metal ions in solution in the range from 0.5 to 2 M, followed by addition of the lithium manganese oxide for positive electrodes of the lithium secondary battery. The solution is heated in order to control the concentration of lithium ions of the solution. The concentration of lithium ions is kept within the range of 0.5 to 2 M. The lithium manganese oxide is uniformly coated by means of a stirrer and then filtered out with a filter paper or in a centrifugal separator at 1000 to 2000 rpm for 10 to 60 minutes.

After filtration, the coated lithium manganese oxide is dried under vacuum at 100 to 130° C. for 2 to 12 hours and then subjected to heat treatment under the oxygen atmosphere or in the air. Preferably, the heat treatment is conducted in the temperature range from 600 to 850° C. for 3 to 48 hours. At temperature and time conditions below the defined range, sufficient crystallization is hardly achieved, whereas above the defined range, the oxide itself is ready to decompose. The lithium metal oxide is formed on a surface of the lithium manganese oxide prior to the heating step.

To prepare the positive electrode of the lithium secondary battery, the lithium manganese oxide composition coated with the active material is milled after the heat treatment and uniformly admixed with a conductive material in a solution of a binder in an organic solvent. The mixed solution is applied to an aluminum foil, which is then dried in a vacuum oven at a temperature around 140° C. for 1 to 4 hours and compacted with a press.

### BRIEF DESCRIPTION OF THE DRAWINGS

FIG. 1a is a graph showing the result of an X-ray diffraction analysis for the lithium manganese oxide;

FIG. 1b is a graph showing the result of an X-ray diffraction analysis for the lithium manganese oxide coated with the lithium cobalt oxide;

FIG. 2 is an EDS analytical photograph showing the surface of the lithium manganese oxide powder coated with the lithium cobalt oxide;

FIG. 3 is a graph showing the variations of the discharge capacity at the room temperature based on the varying number of cycles between charge and discharge for the lithium manganese oxide coated with the lithium cobalt oxide;

FIG. 4 is a graph showing the variations of the discharge capacity at 65° C. based on the varying number of cycles between charge and discharge for the lithium manganese oxide coated with the lithium cobalt oxide; and

FIG. 5 is a graph showing the fast discharge efficiency of the lithium manganese oxide coated with the lithium cobalt oxide.

### DETAILED DESCRIPTION OF THE PREFERRED EMBODIMENT

Hereinafter, the present invention will be described in detail by way of the following examples and experimental examples, which are not intended to limit the scope of the present invention.

### EXAMPLE 1

The feedstock comprising lithium acetate and cobalt acetate weighed at the mole ratio of 1:1 was dissolved in distilled water at 85° C. under agitation with a stirrer in a reaction bath. After addition of glycolic acid in an amount 1.7 times the total weight of metal ion compounds used, ammonia water was added to control the pH value of the solution at 7.

Subsequently, the solution was refluxed at 85° C. for 6 hours maintaining a constant concentration of metal ions of 0.5-2 M by removal of the distilled water through vaporization. The solution was then uniformly mixed with lithium manganese oxide LiMn₂O₄ under agitation with a stirrer, after which it was subjected to centrifugation at 1500 rpm for 30 minutes to obtain the LiCoO₂-coated LiMn₂O₄.

The lithium manganese oxide thus obtained was dried under vacuum at 120° C. for 2 hours and subjected to a heat treatment under the oxygen atmosphere at 800° C. for 6 hours.

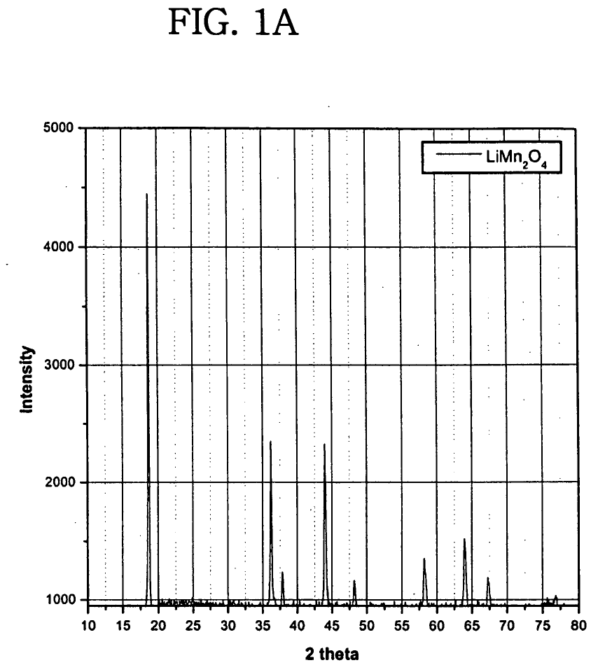

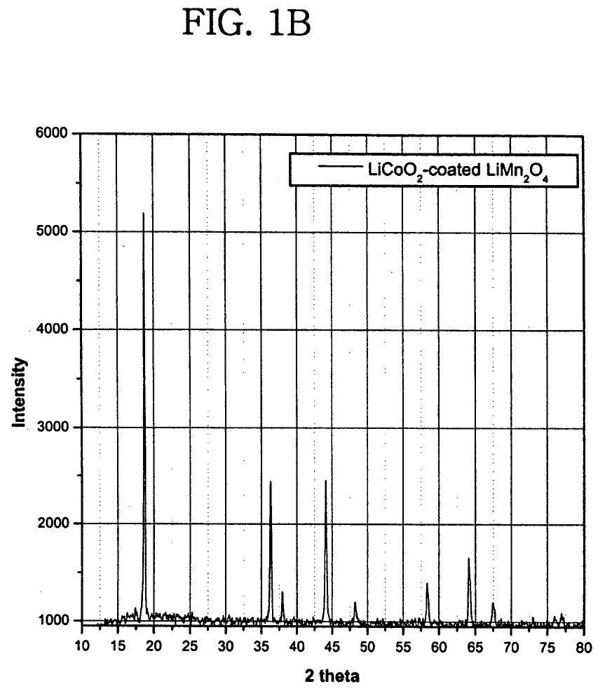

FIG. 1a is a graph showing the result of an X-ray diffraction analysis for the lithium manganese oxide, and FIG. 1b is a graph showing the result of an X-ray diffraction analysis for the lithium manganese oxide coated with the lithium cobalt oxide. A comparison between the two graphs shows that a very small amount of the lithium cobalt oxide was coated on the lithium manganese oxide because there appeared neither a second phase or impurities nor a peak of the lithium cobalt oxide during the coating step.

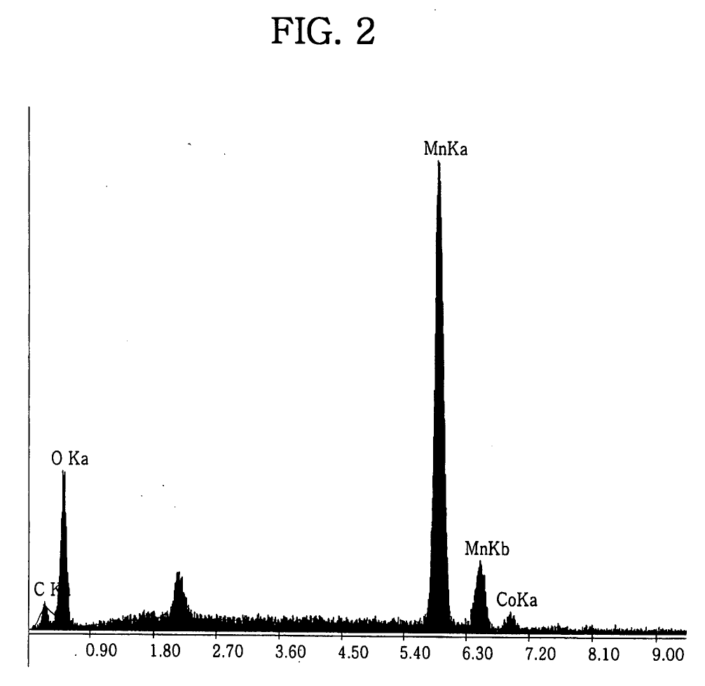

FIG. 2 is an EDS analytical photograph showing the surface of the lithium manganese oxide powder coated with the lithium cobalt oxide. It can be seen that the lithium cobalt oxide was coated on the surface of the lithium manganese oxide because both manganese and cobalt were observed.

Meanwhile, a polyvinylidene binder was dissolved in a N-methylpyrrolidone solvent and then the resulting solution was uniformly mixed with an active material, i.e., the lithium manganese oxide coated with the lithium cobalt oxide and a known conductive material used in the secondary batteries. The mixture was then applied onto an aluminum foil, which was then dried in a vacuum oven at 140° C. and compacted with a press to complete the positive electrode for lithium secondary batteries.

The positive electrode for lithium secondary batteries and the lithium metal foil thus obtained were used to prepare a coin-like half cell made from a stainless steel for charge and discharge tests. The half cell was then subjected to the charge and discharge tests where the negative electrode was lithium and the electrolyte was LiPF₆/EC:DEC (1:1). The charge/discharge rate was in the range of 12 to 120 mA/g with various current densities.

### EXAMPLE 2

The procedures were performed to prepare a half cell in the same manner as Example 1 excepting that the feedstock was comprised of lithium acetate and nickel acetate at the mole ratio of 1:1.

### EXAMPLE 3

The procedures were performed to prepared a half cell in the same manner as Example 1 excepting that the feedstock was comprised of lithium acetate, nickel acetate and cobalt acetate at the mole ratio of 1:0.8:0.2.

### EXAMPLE 4

The procedures were performed to prepared a half cell in the same manner as Example 1 excepting that the feedstock was comprised of lithium acetate, nickel acetate, cobalt acetate and manganese acetate at the mole ratio of 1:0.7:0.2:0.1.

### EXAMPLE 5

The procedures were performed to prepared a half cell in the same manner as Example 1 excepting that the feedstock was comprised of lithium acetate, cobalt acetate and manganese acetate at the mole ratio of 1:0.9:0.1.

### EXAMPLE 6

The procedures were performed to prepared a half cell in the same manner as Example 1 excepting that the feedstock was comprised of lithium acetate, nickel acetate and aluminum acetate at the mole ratio of 1:0.75:0.25.

### EXAMPLE 7

The procedures were performed to prepared a half cell in the same manner as Example 1 excepting that the feedstock was comprised of lithium acetate, manganese acetate and ferric acetate at the mole ratio of 1:1.95:0.05.

### EXPERIMENTAL EXAMPLE 1

Measurement of the discharge capacity at the room temperature based on the varying number of cycles between charge and discharge for the lithium manganese oxide coated with the lithium cobalt oxide.

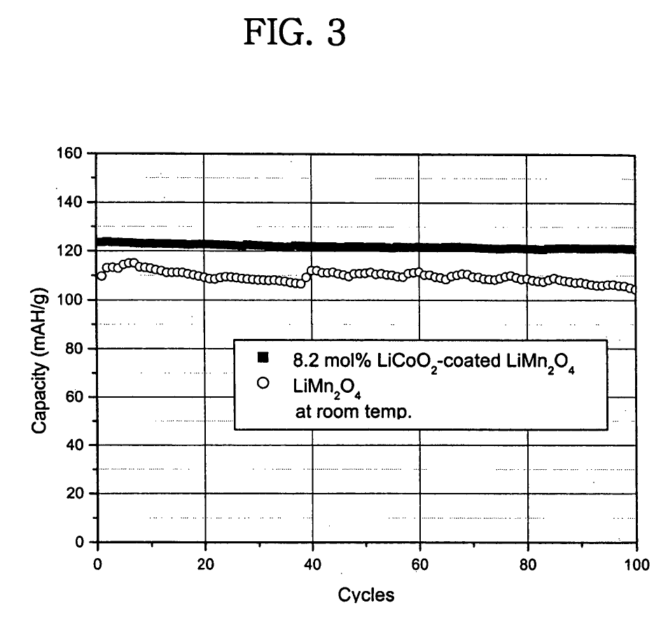

FIG. 3 is a graph showing the variations of the discharge capacity at the room temperature based on the varying number of cycles between charge and discharge for the lithium manganese oxide (LiMn₂O₄) coated with 8.2 mol % of lithium cobalt oxide (LiCoO₂) and uncoated lithium manganese oxide.

As shown in FIG. 3, the lithium manganese oxide coated with the lithium cobalt oxide was superior to the pure lithium manganese oxide in the discharge capacity and the lifetime of the electrodes.

### EXPERIMENTAL EXAMPLE 2

Measurement of the discharge capacity at 65° C. based on the varying number of cycles between charge and discharge for the lithium manganese oxide coated with the lithium cobalt oxide.

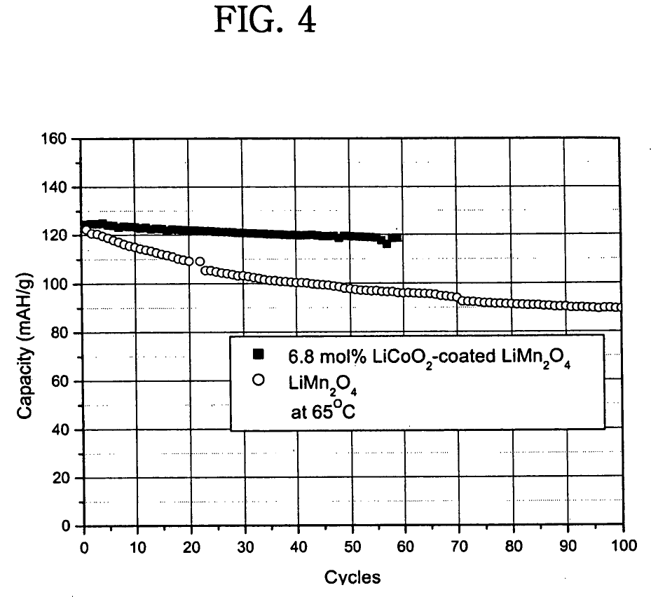

FIG. 4 is a graph showing the variations of the discharge capacity at 65° C. based on the varying number of cycles between charge and discharge for the lithium manganese oxide (LiMn₂O₄) coated with 6.8 mol % of lithium cobalt oxide (LiCoO₂) and uncoated lithium manganese oxide.

As shown in FIG. 4, the lithium manganese oxide coated with the lithium cobalt oxide was superior in the lifetime characteristic of the electrodes at high temperatures to the pure lithium manganese oxide.

### EXPERIMENTAL EXAMPLE 3

Measurement of fast discharge efficiency of lithium manganese oxide coated with lithium cobalt oxide.

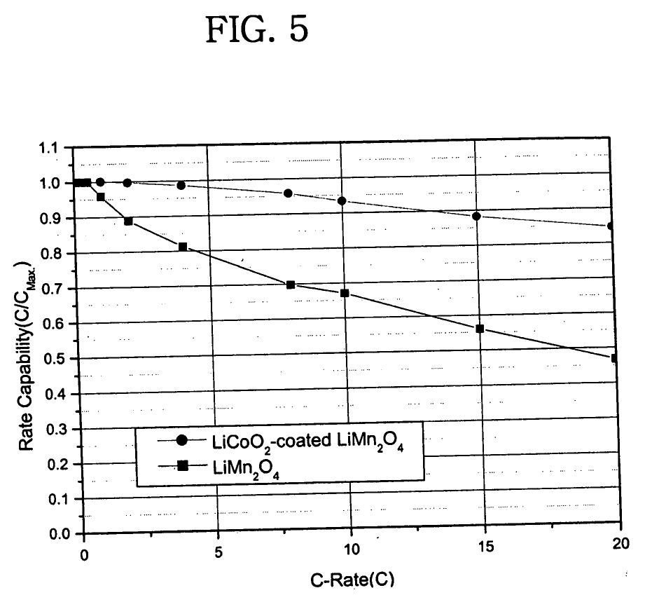

FIG. 5 is a graph showing the fast discharge efficiencies of the lithium manganese oxide coated with the lithium cobalt oxide and pure lithium manganese oxide. As shown in FIG. 5, the lithium manganese oxide coated with the lithium cobalt oxide was superior in the fast discharge efficiency to the pure lithium manganese oxide.

The present invention is directed to development of an inexpensive anode material for high performance lithium secondary batteries that substitutes for the conventional expensive lithium cobalt oxide to greatly reduce the unit cost with increased performance and lifetime of the lithium manganese oxide currently being developed as the conventional anode material for lithium secondary batteries. Consequently, the invention may place more weight on the lithium secondary batteries in the market of secondary batteries broadly used in the electric appliances such as cellular phone, camcorder, notebook computer, etc. and possibly make earlier the development of electric motorcars the most important performance factor of which is inexpensive high-performance secondary batteries.

It is to be noted that like reference numerals denote the same components in the drawings, and a detailed description of generally known function and structure of the present invention will be avoided lest it should obscure the subject matter of the present invention.

What is claimed is:

1. A method for surface treatment of a plurality of lithium manganese oxide particles for positive electrodes in lithium secondary batteries, the method comprising the steps of:
(a) weighing a sample of a lithium compound and a transition metal compound, dissolving the weighed compounds in a solvent to prepare a mixed solution feedstock and adding an acid to the feedstock thereto;
(b) adjusting a pH value of the solution formed in step (a), the pH value being controlled to be in the range from 6 to 8;
(c) heating the solution to control a concentration of lithium ions of the solution, the concentration of lithium ions being controlled within the range from 0.5 to 2 M;
(d) adding the plurality of lithium manganese oxide particles to the solution to prepare a second mixed solution wherein surfaces of the plurality of lithium manganese oxide particles are at least partially coated with a lithium transition metal oxide;
(e) filtering the mixed solution to obtain the lithium manganese oxide surface-coated with the lithium transition metal oxide; and
(f) drying and heat-treating the resulting lithium manganese oxide, said lithium metal oxide being formed on a surface of said lithium manganese oxide prior to heating.

2. The method as claimed in claim 1, wherein the lithium compound and the transition metal compound are each selected from the group consisting of acetates, hydroxides, nitrates, sulfates, and chlorides.

3. The method as claimed in claim 1, wherein the lithium transition metal oxide comprises an oxide selected from the group consisting of LiCoO₂, LiNiO₂, LiNi₁₋ₓCoₓO₂, LiNi_{1-x-y}CoₓM_{y}O₂, LiCo₁₋ₓMₓO₂, LiNi₁₋ₓMₓO₂ and LiMn₂₋ₓJₓO₄, wherein M is a metal selected from the group consisting of Fe, Mn, V, Cr, Cu, Ti, W, Ta, and Mo; wherein J is a metal selected from the group consisting of Fe, V, Cr, Cu, Ti, W, Ta and Mo; and x and y independently represent an atomic fraction of the elements of the oxide, wherein 0<x≦0.5 and 0<y≦0.5.

4. The method as claimed in claim 1, wherein in the filtration step (e), the lithium manganese oxide surface coated with the lithium transition metal oxide is passed through a filter paper or subjected to centrifugal separation at a speed of 1000 to 2000 rpm for 1 to 60 minutes.

5. A method for surface treatment of a plurality of lithium manganese oxide particles for positive electrodes in lithium secondary batteries, the method comprising the steps of:
(a) weighing a sample of a lithium compound and a transition metal compound, dissolving the weighed compounds in a solvent to prepare a mixed solution feedstock and adding an acid to the feedstock thereto;
(b) adjusting a pH value of the solution formed in step (a), the pH value being controlled to be in the range from 6 to 8;
(c) heating the solution to control a concentration of lithium ions of the solution, the concentration of lithium ions in said solution being controlled within the range from 0.5 to 2M;
(d) adding the plurality of lithium manganese oxide particles to the solution to prepare a second mixed solution wherein surfaces of the plurality of lithium manganese oxide particles are at least partially coated with a lithium transition metal oxide;
(e) filtering the second mixed solution to obtain the lithium manganese oxide surface-coated with the lithium transition metal oxide; and
(f) drying and heat-treating the resulting lithium manganese oxide at a temperature in a range of 600 to 850° C. for 3 to 48 hours in an oxygen atmosphere or in air, said lithium metal oxide being formed on a surface of said lithium manganese oxide prior to heating.
